(19) United States
(12) Patent Application Publication
(10) Pub. No.: US 2006/0062436 A1
(43) Pub. Date: Mar. 23, 2006

(54) Fingerprint verification system for door

(76) Inventor: Juin-Hung Chen, Taipei City (TW)

Correspondence Address: Juin-Hung Chen, P.O. Box No. 6-57, Junghe, Taipei, 235, TW

(21) Appl. No.: 10/945,957

(22) Filed: Sep. 22, 2004

(51) Int. Cl. G06K 9/00; G05B 19/00

(52) U.S. Cl. 382/124; 340/5.53

(57) ABSTRACT

A fingerprint verification system for a door includes a digital signal processor (DSP) for being attached to a door, a fingerprint information capturing key and a signal receiving port. Whereby in use, the connector of the fingerprint information capturing key is electrically connected with the signal receiving port. A finger of a user is scanned by the fingerprint information capturing unit for capturing fingerprint information of the user. The captured fingerprint information is transmitted to the DSP through the connector and the signal receiving port for being verified against previous stored fingerprint information. The fingerprint verification system can release a lock of the door or open the door only if they match.

### BACKGROUND OF THE INVENTION

(a) Field of the Invention

The present invention relates to a fingerprint verification system for a door, and particularly to a fingerprint verification system for a door with a fingerprint information capturing unit being formed at a key.

(b) Description of the Prior Art

Referring to FIG. 4, a conventional fingerprint verification system for a door includes a fingerprint information capturing unit 10 disposed at a door 20 for capturing fingerprint information from a user's finger. The captured fingerprint information is transmitted from the fingerprint information capturing unit 10 to the fingerprint verification system and then is verified against previous stored fingerprint information. The fingerprint verification system can release a lock of the door only if they match. Thus, the fingerprint verification system for a door is safe, highly efficient and convenient and so is widely applied to intelligent buildings, office buildings, residential housings, prisons, machine rooms, confidential rooms, bank cashboxes and so on as an entrance guard.

The fingerprint verification system for a door is used to replace a conventional key. However, when the fingerprint information capturing unit 10 is damaged or failed and so cannot work normally, the fingerprint verification system becomes unsafe and inconvenient. Furthermore, since the fingerprint information capturing unit 10 is provided to be directly pressed by fingers for capturing fingerprint information, a lot of bacteria are ready to occur on the surface of the fingerprint information capturing unit 10, which is unhealthful in use.

### SUMMARY OF THE INVENTION

Accordingly, an object of the present invention is to provide a fingerprint verification system for a door with a fingerprint information capturing unit formed with a key separated from the fingerprint verification system thereby preventing from making the fingerprint verification system unsafe and inconvenient when the fingerprint information capturing unit does not work normally.

Another object of the present invention is to provide a fingerprint verification system for a door with a fingerprint information capturing unit formed with a key separated from the fingerprint verification system for personal use thereby preventing from making the fingerprint information capturing unit unhealthful in use.

To achieve the above-mentioned objects, a fingerprint verification system for a door in accordance with the present invention includes a digital signal processor (DSP) for being attached to a door, a fingerprint information capturing key and a signal receiving port. The fingerprint information capturing key includes a fingerprint information capturing unit formed at a body thereof, and a connector formed at a front end thereof. The fingerprint information capturing unit and the connector are in communication connection. The signal receiving port for being fixed to the door is electrically connectable with the connector. The signal receiving port and the DSP are in communication connection. Whereby in use, the connector of the fingerprint information capturing key is electrically connected with the signal receiving port. A finger of a user is scanned by the fingerprint information capturing unit for capturing fingerprint information of the user. The captured fingerprint information is transmitted to the DSP through the connector and the signal receiving port for being verified against previous stored fingerprint information. The fingerprint verification system can release a lock of the door or open the door only if they match. Other objects, advantages and novel features of the present invention will be drawn from the following detailed embodiments of the present invention with attached drawings, in which:

### BRIEF DESCRIPTION OF THE DRAWINGS

FIG. 1 is a schematic view of a fingerprint verification system for a door of the present invention;

FIG. 2 is a perspective view of a fingerprint information capturing key of the fingerprint verification system;

FIG. 3 is a perspective view of a fingerprint information capturing key of the fingerprint verification system in accordance with an alternative embodiment of the present invention;

FIG. 4 is a schematic view of a conventional fingerprint verification system for a door.

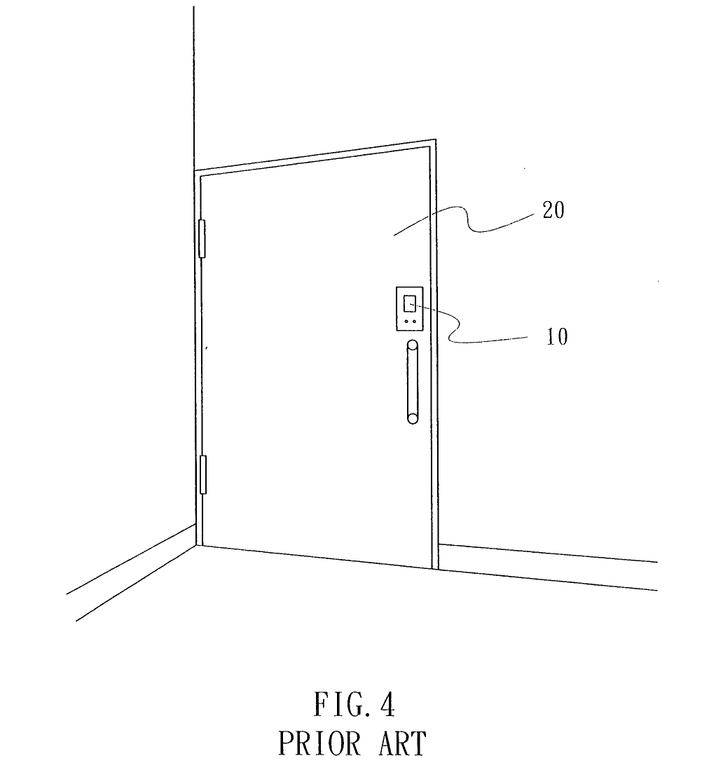

### DESCRIPTION OF THE PREFERRED EMBODIMENTS

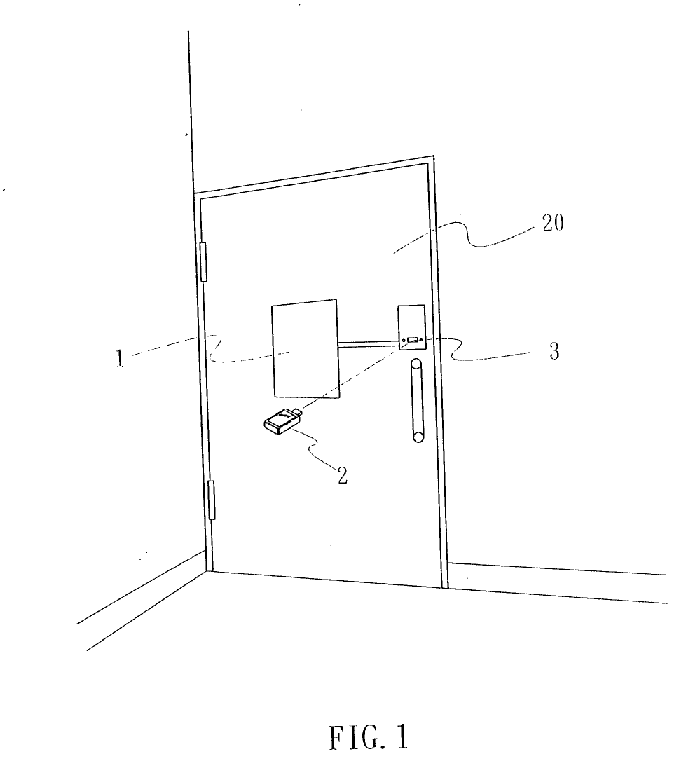

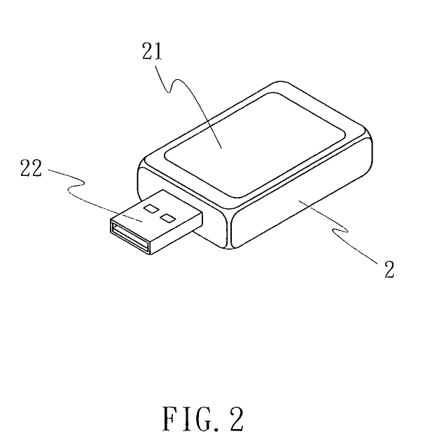

Referring to FIGS. 1 and 2, a fingerprint verification system for a door of the present invention includes a digital signal processor (DSP) 1 attached to a door 20, a fingerprint information capturing key 2 and a signal receiving port 3. The DSP 1 is an arithmetic system for dealing with a digital signal from an input and includes a storage device and a Boolean calculation unit for verifying the input digital signal against previous stored signals. The DSP 1 is conventionally disclosed and so is not described detailedly herein.

The fingerprint information capturing key 2 includes a fingerprint information capturing unit 21 formed at a body thereof, and a connector 22 formed at a front end thereof. The fingerprint information capturing unit 21 and the connector 22 are in communication connection.

The signal receiving port 3 is fixed to the door 20 and is electrically connectable with the connector 22. The signal receiving port 3 and the DSP 1 are in communication connection.

In use, the connector 22 of the fingerprint information capturing key 2 is connected with the signal receiving port 3 for communication connection with the signal receiving port 3. A finger of a user is scanned by the fingerprint information capturing unit 21 for capturing fingerprint information of the user. The captured fingerprint information is transmitted to the DSP 1 through the connector 22 and the signal receiving port 3 for being verified against previous stored fingerprint information. The fingerprint verification system can release a lock of the door 20 or open the door 20 only if they match.

The fingerprint information capturing unit 21 of the fingerprint verification system for a door of the present invention is formed at the key 2 separated from the fingerprint verification system thereby preventing from making the fingerprint verification system unsafe and inconvenient when the fingerprint information capturing unit 21 does not work normally. The fingerprint information capturing unit 21 of the key 2 may adopt optical scanning technology in which CMOS or CCD is used as a sensitization module, capacitance scanning technology, thermoelectricity scanning technology, or electric field scanning technology for reducing power consumption thereof and controlling manufacturing cost of the key 2 thereby facilitating mass production. When the key 2 is lost or damaged, a new key 2 may be ready to make and afford. Furthermore, the fingerprint information capturing key 2 transmits the fingerprint information through real time scanning, and does not record. So, the fingerprint information capturing key 2 is functioned as an auxiliary digital signal input device with respect to the DSP 1 whereby the previous stored fingerprint information cannot be betrayed through the fingerprint information capturing key 2. Thus, the fingerprint information capturing key 2 is safe in use.

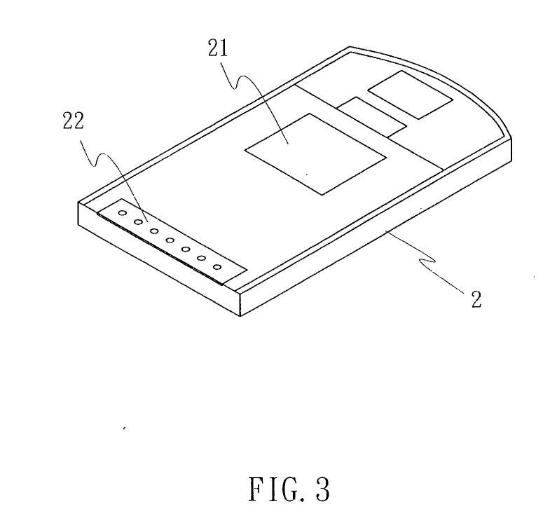

Configurations of the connector 22 and the receiving port 3 may adopt different signal transmission interfaces, such as a USB interface, an IEEE1394 interface, an infrared port interface or a COM port interface. Furthermore, the fingerprint information capturing key 2 may be configured as an interface card or a memory card, such as a PCMCIA card (as shown in FIG. 3) or a CF card. The connector 22 and the receiving port 3 are formed to be complementary for communication connection with each other.

The fingerprint verification system for a door of the present invention provides two solutions to supply the fingerprint information capturing key 2 with power for scanning a finger and capturing fingerprint information of the finger. One is to provide a power supply module (such as a mercury cell) within the body of the key 2. Since the power consumption of the key 2 is quite low, one power supply module can support the key 2 to run in a long time. The other is to provide a designated power from the fingerprint verification system to the fingerprint information capturing key 2 through the receiving port 3 and the connector 22 when the connector 22 connects with the receiving port 3.

Additionally, the fingerprint information capturing unit 21 of the fingerprint verification system for a door of the present invention is formed at the key 2 separated from the DSP 1 for personal use thereby preventing from making the fingerprint information capturing unit unhealthful in use since every user has his personal fingerprint information capturing unit 21.

It is understood that the invention may be embodied in other forms without departing from the spirit thereof. Thus, the present example and embodiment are to be considered in all respects as illustrative and not restrictive, and the invention is not to be limited to the details given herein.

What is claimed is:

1. A fingerprint verification system for a door comprising a digital signal processor (DSP) for being attached to a door, a fingerprint information capturing key and a signal receiving port, wherein
the fingerprint information capturing key includes a fingerprint information capturing unit formed at a body thereof, and a connector formed at a front end thereof, the fingerprint information capturing unit and the connector are in communication connection;
the signal receiving port for being fixed to the door is electrically connectable with the connector, the signal receiving port and the DSP are in communication connection;
Whereby in use, the connector of the fingerprint information capturing key is electrically connected with the signal receiving port, a finger of a user is scanned by the fingerprint information capturing unit for capturing fingerprint information of the user, the captured fingerprint information is transmitted to the DSP through the connector and the signal receiving port for being verified against previous stored fingerprint information, the fingerprint verification system can release a lock of the door or open the door only if they match.

2. The fingerprint verification system for a door as claimed in claim 1, wherein the fingerprint information capturing unit of the key adopts optical scanning technology.

3. The fingerprint verification system for a door as claimed in claim 2, wherein the fingerprint information capturing unit of the key uses CMOS as a sensitization module.

4. The fingerprint verification system for a door as claimed in claim 2, wherein the fingerprint information capturing unit of the key uses CCD as a sensitization module.

5. The fingerprint verification system for a door as claimed in claim 1, wherein the fingerprint information capturing unit of the key adopts capacitance scanning technology.

6. The fingerprint verification system for a door as claimed in claim 1, wherein the fingerprint information capturing unit of the key adopts thermoelectricity scanning technology.

7. The fingerprint verification system for a door as claimed in claim 1, wherein the fingerprint information capturing unit of the key adopts electric field scanning technology.

8. The fingerprint verification system for a door as claimed in claim 1, wherein the connector of the key adopts a USB interface.

9. The fingerprint verification system for a door as claimed in claim 1, wherein the receiving port adopts a USB interface.

10. The fingerprint verification system for a door as claimed in claim 1, wherein a power supply module is provided within the body of the fingerprint information capturing key.

11. The fingerprint verification system for a door as claimed in claim 1, wherein a designated power from the fingerprint verification system is provided to the fingerprint information capturing key through the receiving port and the connector when the connector connects with the receiving port.
